(19) United States
(12) Patent Application Publication
(10) Pub. No.: US 2025/0079894 A1
(43) Pub. Date: Mar. 6, 2025

(54) WIRELESS CHARGER AND CHARGING METHOD

(71) Applicant: VIVO MOBILE COMMUNICATION CO., LTD., Dongguan (CN)

(72) Inventor: Yadong JIANG, Dongguan (CN)

(73) Assignee: VIVO MOBILE COMMUNICATION CO., LTD., Dongguan (CN)

(21) Appl. No.: 18/954,432

(22) Filed: Nov. 20, 2024

Related U.S. Application Data
(63) Continuation of application No. PCT/CN2023/095021, filed on May 18, 2023.

(30) Foreign Application Priority Data
May 25, 2022 (CN) 202210578909.X

(51) Int. Cl. H02J 50/10; H02J 7/00; H02J 50/90

(52) U.S. Cl. CPC H02J 50/10; H02J 7/0042; H02J 50/90

(57) ABSTRACT

A wireless charger and a charging method are provided. The wireless charger includes a substrate, an upper cover plate, a pressure-sensitive component, and a magnetic component. The substrate and the upper cover plate are stacked in a first direction. The upper cover plate is able to move relative to the substrate along the first direction. The pressure-sensitive component is disposed on a side of the substrate facing the upper cover plate. The pressure-sensitive component is electrically connected to the magnetic component. The pressure-sensitive component is configured to detect a pressure value of the upper cover plate pressed on the substrate. The wireless charger adjusts at least one of magnetic direction or magnetic force of the magnetic component based on the pressure value.

### CROSS-REFERENCE TO RELATED APPLICATIONS

This application is a continuation of International Application No. PCT/CN2023/095021, filed on May 18, 2023, which claims priority to Chinese Patent Application No. 202210578909.X filed on May 25, 2022. The entire contents of each of the above-referenced applications are expressly incorporated herein by reference.

### TECHNICAL FIELD

This application pertains to the field of wireless charging technology, and specifically relates to a wireless charger and a charging method.

### BACKGROUND

Based on the principle of electromagnetic induction, the wireless charger generates current through electromagnetic induction between the primary coil and the secondary coil, so as to transfer energy within a spatial range. With the popularization of wireless charging technology, along with its convenient and quick charging, it has gained favor among consumers.

Wireless chargers are categorized based on the contact mode into ordinary contact, magnetic contact, and back clip contact. The magnetic wireless charger, with a magnetic ring mounted around the periphery of the coil and a magnetic ring with opposite polarity mounted around the periphery of the coil of the phone, can achieve the alignment effect when the phone comes close to the magnetic wireless charger. Compared to the ordinary wireless charger, the magnetic wireless charger can use magnetism to achieve precise alignment of the charging coil, improving placement accuracy and charging efficiency. However, once the phone is attached to the magnetic wireless charger, the user needs to manually separate the phone from the magnetic wireless charger, resulting in poor convenience in use of the magnetic wireless charger.

### SUMMARY

The embodiments of this application are intended to provide a wireless charger and a charging method.

This application is implemented as follows.

According to a first aspect, an embodiment of this application provides a wireless charger including a substrate, an upper cover plate, a pressure-sensitive component, and a magnetic component; where the substrate and the upper cover plate are stacked in a first direction, the upper cover plate is able to move relative to the substrate along the first direction, and the pressure-sensitive component is disposed on a side of the substrate facing the upper cover plate; and the pressure-sensitive component is electrically connected to the magnetic component, the pressure-sensitive component is configured to detect a pressure value of the upper cover plate pressed on the substrate, and the wireless charger adjusts at least one of magnetic direction and magnetic force of the magnetic component based on the pressure value.

According to a second aspect, an embodiment of this application further provides a charging method applied to the wireless charger according to the first aspect. The method includes:
detecting a pressure value between the upper cover plate and the substrate;
determining state information of the wireless charger based on the pressure value; and
in a case that it is determined based on the state information that the wireless charger is in a target state, controlling the magnetic component to deactivate, where the magnetic component is configured to generate a magnetic force for attaching a device to be charged to the upper cover plate when activated.

The wireless charger provided in the embodiments of this application includes a substrate, an upper cover plate, a pressure-sensitive component, and a magnetic component; where the substrate and the upper cover plate are stacked in a first direction, the upper cover plate is able to move relative to the substrate along the first direction, and the pressure-sensitive component is disposed on a side of the substrate facing the upper cover plate; and the pressure-sensitive component is electrically connected to the magnetic component, the pressure-sensitive component is configured to detect a pressure value of the upper cover plate pressed on the substrate, and the wireless charger adjusts at least one of magnetic direction and magnetic force of the magnetic component based on the pressure value. Thus, when the wireless charger provided in the embodiments of this application is charging the device to be charged, the device to be charged is attached to the upper cover plate, and the pressure-sensitive component detects whether a user removes the device to be charged from the upper cover plate, thereby deactivating the magnetic component. This allows the user to smoothly remove the device to be charged from the wireless charger.

### BRIEF DESCRIPTION OF DRAWINGS

FIG. 1 is a front view of a wireless charger with an upper cover plate and a substrate separated according to an embodiment of this application;

FIG. 2 is a partial schematic structural diagram of a wireless charger with an upper cover plate removed according to an embodiment of this application;

FIG. 3 is a side view of a wireless charger with an upper cover plate and a substrate separated according to an embodiment of this application;

FIG. 4 is an enlarged view of region A in FIG. 3 according to an embodiment of this application;

FIG. 5 is a flowchart of a charging method according to an embodiment of this application; and

FIG. 6 is a schematic structural diagram of a charging means according to an embodiment of this application.

### DETAILED DESCRIPTION OF EMBODIMENTS

The following clearly describes the technical solutions in the embodiments of this application with reference to the accompanying drawings in the embodiments of this application. Apparently, the described embodiments are only some but not all of the embodiments of this application. All other embodiments obtained by persons of ordinary skill in the art based on the embodiments of this application without creative efforts shall fall within the protection scope of this application.

The terms “first”, “second”, and the like in the specification and claims of this application are used to distinguish between similar objects rather than to describe a specific order or sequence. It should be understood that data used in this way are interchangeable in appropriate circumstances so that the embodiments of this application can be implemented in an order other than those illustrated or described herein. In addition, “first”, “second”, and the like are typically used to distinguish objects of a same type and do not limit quantities of the objects. For example, there may be one or more first objects. In addition, in the specification and claims, “and/or” indicates at least one of the connected objects, and the character “/” generally indicates an “or” relationship between the contextually associated objects.

The following describes in detail the wireless charger provided in the embodiments of this application through embodiments and application scenarios thereof with reference to the accompanying drawings.

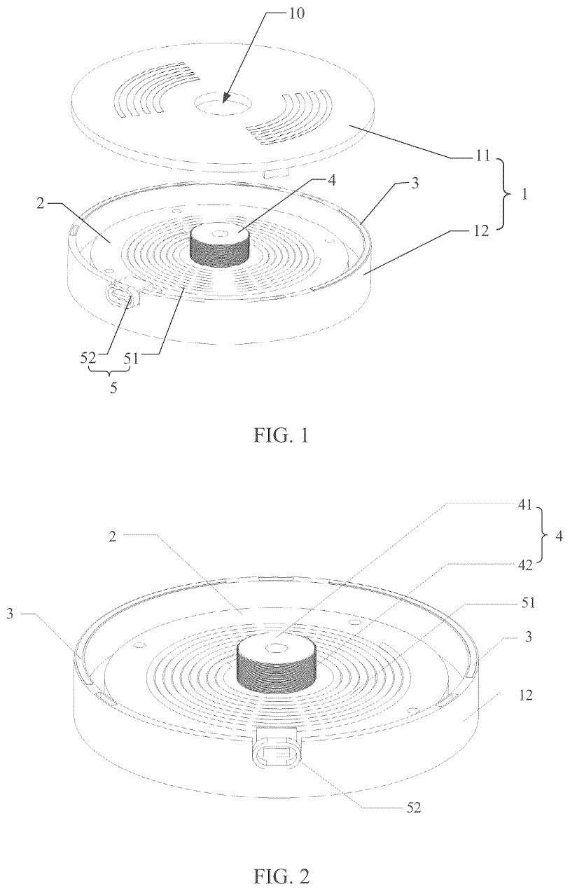

Referring to FIG. 1, the wireless charger provided in the embodiments of this application includes a substrate 12, an upper cover plate 11, a pressure-sensitive component 3, and a magnetic component 4.

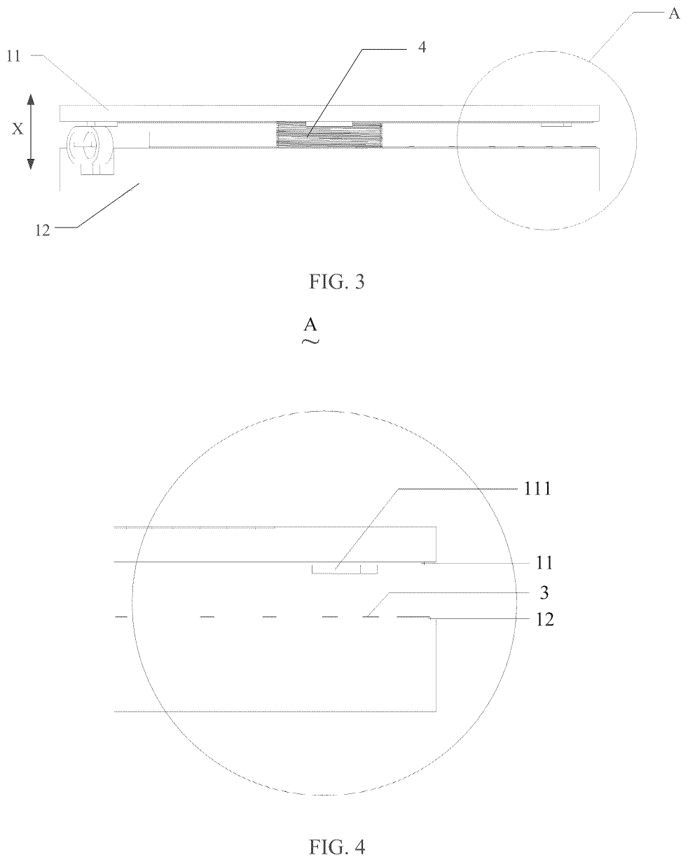

The substrate 12 and the upper cover plate 11 are stacked in a first direction (such as a direction X in FIG. 3), the upper cover plate 11 is able to move relative to the substrate 12 along the first direction, and the pressure-sensitive component 3 is disposed on a side of the substrate 12 facing the upper cover plate 11.

The pressure-sensitive component 3 is electrically connected to the magnetic component 4, the pressure-sensitive component 3 is configured to detect a pressure value of the upper cover plate 11 pressed on the substrate 12, and the wireless charger adjusts at least one of magnetic direction and magnetic force of the magnetic component 4 based on the pressure value.

In an implementation, as shown in FIG. 1, the substrate 12 and the upper cover plate 11 can fit together to form a housing 1, other structures such as the pressure-sensitive component 3 and the magnetic component 4 can be accommodated in an accommodating cavity inside the housing 1, and the substrate 12 and the upper cover plate 11 can move relative to each other along the first direction X. For example, when the wireless charger provided in the embodiments of this application is charging a device to be charged, the device to be charged is carried on the upper cover plate 11, so that the upper cover plate 11 is pressed toward the substrate 12 under the gravity of the device to be charged. In this case, a pressure value detected by the pressure-sensitive component 3 is greater than a pressure value when no device to be charged is carried on the upper cover plate 11. When the wireless charger provided in the embodiments of this application is not charging the device to be charged or when a user picks up the device to be charged, the upper cover plate 11 can move away from the substrate 12.

The pressure-sensitive component 3 may include a pressure detection means for detecting a pressure on the upper cover plate 11, or the pressure-sensitive component 3 may include a pressure-sensitive resistor. For example, a greater pressure on the pressure-sensitive resistor means a smaller current value. Thus, a corresponding pressure value can be determined based on a magnitude of a current value output by the pressure-sensitive component 3. The pressure-sensitive component 3 is not limited to a specific type herein.

In addition, the magnetic component 4 may be any structure with adjustable magnetic field direction and/or magnetic field strength. For example, the magnetic component 4 includes an electromagnet, which can adjust a magnetic field strength generated by the magnetic component 4 by adjusting a magnitude of a current flowing through the electromagnet, and/or can adjust a magnetic field direction generated by the magnetic component 4 by adjusting a direction of a current flowing through the electromagnet.

In an implementation, the pressure-sensitive component 3 may be set as a pressure-sensitive resistor where a greater pressure on the pressure-sensitive resistor means a greater current output, and the magnetic component 4 includes an electromagnet. Thus, with the current output by the pressure-sensitive resistor input to the electromagnet, the magnetic field strength of the magnetic component 4 can be adjusted based on the pressure on the upper cover plate 11, which allows the magnetic force generated by the magnetic component 4 to decrease as the pressure on the upper cover plate 11 decreases. For example, when the user picks up the device to be charged attached to the upper cover plate 11, the magnetic force generated by the magnetic component 4 decreases, thereby allowing the device to be charged to separate from the wireless charger.

In an implementation, a control module 2 may further be disposed in the wireless charger, where the control module 2 is connected to both the pressure-sensitive component 3 and the magnetic component 4. Thus, the control module 2 can determine whether the wireless charger is in a target state based on an output signal of the pressure-sensitive component 3 and adjust the magnetic force generated by the magnetic component 4 accordingly. The target state may be a state in which the user removes the device to be charged from the wireless charger. In this case, the pressure-sensitive component 3 can detect whether the device to be charged is carried on the upper cover plate 11 by detecting the pressure on the upper cover plate 11, so that the control module 2 can determine that the wireless charger is in the target state in a case that the pressure on the upper cover plate 11 is less than or equal to a first preset value, or the control module 2 can determine that the wireless charger is in the target state in the case of obtaining N pieces of state information indicating that the pressure on the upper cover plate 11 is greater than or equal to the first preset value, where N is an even number greater than 0, or the control module 2 can determine that the wireless charger is in the target state in the case of obtaining information indicating that no device to be charged is carried on the upper cover plate 11.

Correspondingly, the control module 2 can determine that the wireless charger is in a non-target state (for example, a state in which the wireless charger is normally charging the device to be charged) in a case that the pressure on the upper cover plate 11 is greater than or equal to the first preset value, or the control module 2 can determine that the wireless charger is in the non-target state in the case of obtaining M pieces of state information indicating that the pressure on the upper cover plate 11 is greater than or equal to the first preset value, where M is an odd number greater than 0, or the control module 2 can determine that the wireless charger is in the non-target state in the case of obtaining information indicating that the device to be charged is carried on the upper cover plate 11. The non-target state may be a state in which the wireless charger is wirelessly charging the device to be charged carried on the upper cover plate 11.

The state information output by the pressure-sensitive component 3 may be a digital signal or an analog signal. The control module 2 may be any means, logical unit, control circuit, switch circuit, control chip, or the like that is capable of generating a corresponding output signal based on the received signal, which is not specifically limited herein. For example, assuming that the pressure-sensitive component 3 can output an electrical signal of a first value in the case of detecting that the device to be charged is carried on the upper cover plate 11, and the pressure-sensitive component 3 can output an electrical signal of a second value in the case of detecting that no device to be charged is carried on the upper cover plate 11, then the control module 2 can determine that no device to be charged is carried on the upper cover plate 11 in the case of receiving the electrical signal of the second value from the pressure-sensitive component 3, thereby determining that the wireless charger is in the target state.

In a possible implementation, the pressure-sensitive component 3 is a pressure detection means for detecting the pressure on the upper cover plate 11. In a normal charging state, the upper cover plate 11 bears weight of the entire device to be charged, thus leading to a large pressure. When the user needs to remove the device to be charged, the user lifts the device to be charged, and the weight on the upper cover plate 11 at this time is significantly less than the weight of the entire device to be charged, thus leading to a small pressure. Based on this, in a case that the pressure-sensitive component 3 detects that the pressure received by the upper cover plate 11 is less than or equal to a first preset pressure value (the first preset pressure value may be set based on weight of a device to be charged adapted to the wireless charger provided in the embodiments of this application, or the first preset pressure value is set to 0), the control module 2 can determine that the wireless charger is in the target state, and then control the wireless charger to exit a charging mode. Correspondingly, in a case that the pressure-sensitive component 3 detects that the pressure received by the upper cover plate 11 is greater than or equal to the first preset pressure value (the first preset pressure value may be set based on the weight of the device to be charged adapted to the wireless charger provided in the embodiments of this application, or the first preset pressure value is set to 0), the control module 2 can determine that the wireless charger is in the non-target state, and then control the wireless charger to enter the charging mode.

In a possible implementation, the pressure-sensitive component 3 is a pressure detection means for detecting the pressure on the upper cover plate 11. In a case that the pressure-sensitive component 3 detects that the pressure received by the upper cover plate 11 is greater than or equal to a second preset pressure value (which may be 0 or a pressure value slightly greater than 0), it may indicate that the user is pressing the upper cover plate 11. The control module 2 can activate the magnetic component 4 to enter the charging mode in a case that the number of times the user presses the upper cover plate 11 is odd. Correspondingly, the control module 2 can deactivate the magnetic component 4 to exit the charging mode in a case that the number of times the user presses the upper cover plate 11 is even.

It should be noted that in the embodiments of this application, the control module 2 controlling the wireless charger to enter the charging mode may be controlling the magnetic component 4 to attach the device to be charged to the upper cover plate 11 and controlling a charging module 5 in the wireless charger to start to charge the device to be charged. Correspondingly, the control module 2 controlling the wireless charger to exit the charging mode may be controlling the magnetic component 4 to deactivate so that the user can easily remove the device to be charged from the upper cover plate 11 and controlling the charging module 5 in the wireless charger to stop charging the device to be charged.

In some embodiments, the control module 2 is further configured to control the magnetic component 4 to generate a magnetic force corresponding to the non-target state in a case that it is determined based on the state information that the wireless charger is in the non-target state.

In an implementation, the magnetic force corresponding to the non-target state may be a minimum magnetic force required for maintaining the attachment of the device to be charged to the upper cover plate 11, thereby reducing power consumption of the magnetic component 4.

In some embodiments, the magnetic component 4 may be any means with controllable magnetic force magnitude and/or direction. For example, in the embodiment shown in FIG. 2, the magnetic component 4 includes a magnetic conductor 41 and a first coil 42 disposed around the periphery of the magnetic conductor 41, and a radial direction of the magnetic conductor 41 is the same as the first direction.

In an implementation, in a case that the pressure value increases, current in the first coil 42 increases and/or the current in the first coil 42 flows along a second direction. When the current along the second direction flows through the first coil 42, the magnetic conductor 41 generates a magnetic force in a third direction, where the third direction is from the upper cover plate 11 toward the substrate 12.

In application, when the device to be charged is placed on the upper cover plate 11 of the wireless charger provided in the embodiments of this application, if the magnetic conductor 41 generates the magnetic force in the third direction, the magnetic force can attach the device to be charged to the upper cover plate 11 of the wireless charger, thereby implementing a magnetic alignment function.

It should be noted that in an implementation, the current in the first coil 42 may always flow along the second direction, and a magnitude of the magnetic force in the third direction generated by the magnetic conductor 41 is adjusted by adjusting a magnitude of the current in the first coil 42. Thus, when the device to be charged is placed on the upper cover plate 11 of the wireless charger provided in the embodiments of this application, increasing the current in the first coil 42 can make the magnetic force in the third direction generated by the magnetic conductor 41 sufficient to attach the device to be charged to the upper cover plate 11 of the wireless charger, thereby implementing the magnetic alignment function. Conversely, when the user removes the device to be charged from the upper cover plate 11, the pressure value detected by the pressure-sensitive component 3 decreases, causing the current in the first coil 42 to decrease, which can make the magnetic force generated by the magnetic conductor 41 insufficient to firmly attach the device to be charged to the upper cover plate 11 of the wireless charger. In this case, when the user picks up the device to be charged, the device to be charged can easily separate from the wireless charger.

In an implementation, the magnetic conductor 41 is made of a magnetic material, which may be soft iron or silicon steel that is easily magnetized and demagnetized. Thus, when the first coil 42 is energized, the magnetic conductor 41 generates a magnetic force under the effect of electromagnetic induction.

The magnetic force in the third direction generated by the magnetic conductor 41 may be a direction of attaching the device to be charged to the upper cover plate 11. In addition, when the pressure value is less than a preset value, the direction of the current in the first coil 42 can be adjusted, so that the magnetic force generated by the magnetic conductor 41 pushes the device to be charged away from the upper cover plate 11 or even causes the device to be charged to suspend above the upper cover plate 11.

In this implementation, the first coil 42 is disposed around the magnetic conductor 41 to adjust the magnitude and direction of the magnetic force generated by the magnetic conductor 41 based on the principle of electromagnetic induction.

In an implementation, the control module 2 may adjust the direction and/or magnitude of the current in the first coil 42 based on an angle of the upper cover plate 11 detected by the pressure-sensitive component 3.

In a possible implementation, the wireless charger provided in the embodiments of this application further includes a base (not shown in the figure), where the substrate 12 is hinged to the base.

A first included angle is formed between the substrate 12 and the base, and a magnitude of a magnetic force between the magnetic component 4 and the device to be charged is positively correlated with the first included angle.

In an implementation, the base may be placed on a table, and the first included angle between the substrate 12 and the base can be adjusted based on a hinge structure between the substrate 12 and the base.

For example, assuming that the magnetic component 4 is configured to attach the device to be charged to the upper cover plate 11, the substrate 12 and the upper cover plate 11 are stacked, and the base remains parallel to the horizontal plane, then when the substrate 12 is parallel to the horizontal plane, the magnetic conductor 41 only needs to provide a small attractive force to achieve the alignment effect of attaching the device to be charged to the upper cover plate 11; and when the included angle between the upper cover plate 11 and the horizontal plane is greater than 0, the magnetic conductor 41 needs to provide a large attractive force to achieve the alignment effect of attaching the device to be charged to the upper cover plate 11. Thus, the control module 2 can adjust the magnitude of the current in the first coil 42 based on the included angle between the substrate 12 and the horizontal plane.

In this implementation, the magnitude of the current in the first coil 42 can be adjusted based on the included angle between the substrate 12 and the base, which decreases the magnitude of the current in the first coil 42 as much as possible while ensuring that the magnetic component 4 can provide the magnetic alignment effect for the device to be charged, thereby reducing the power consumption.

In some embodiments, as shown in FIG. 1, the magnetic conductor 41 is fixed on a side of the substrate 12 facing the upper cover plate 11, the upper cover plate 11 is provided with a through hole 10, and an end of the magnetic conductor 41 is exposed outside the upper cover plate 11 through the through hole 10.

In this implementation, the upper cover plate 11 is provided with the through hole 10, so that the end of the magnetic conductor 41 facing away from the substrate 12 is exposed outside the upper cover plate 11 through the through hole 10, reducing the shielding effect of the upper cover plate 11 on magnetic lines of force of the magnetic conductor 41.

In some embodiments, as shown in FIG. 1, FIG. 3, and FIG. 4, a protrusion 111 is provided on a side of the upper cover plate 11 facing the substrate 12, and the protrusion 111 is disposed opposite the pressure-sensitive component 3.

In a case that the upper cover plate 11 moves toward the substrate 12, the protrusion 111 is pressed on the pressure-sensitive component 3.

In an implementation, the upper cover plate 11 and the substrate 12 may be slidably connected through a snap-fit structure, allowing the upper cover plate 11 to move closer to or away from the substrate 12 within a range.

In this implementation, the wireless charger includes the upper cover plate 11 and the substrate 12 slidably connected. Thus, when the upper cover plate 11 carries an object or receives a press operation by the user, the upper cover plate 11 slides toward the substrate 12, so that the protrusion 111 is pressed on the pressure-sensitive component 3, allowing the pressure-sensitive component 3 to detect the pressure value received by the upper cover plate 11.

In an implementation, the control module 2, the pressure-sensitive component 3, the magnetic component 4, the charging module 5, and the like may be accommodated between the upper cover plate 11 and the substrate 12, ensuring a complete appearance of the wireless charger.

In a case that the upper cover plate 11 moves toward the substrate 12, the protrusion 111 is pressed on the pressure-sensitive component 3, causing the pressure-sensitive component 3 to deform.

Further, the pressure-sensitive component 3 includes a strain resistor or a Microelectromechanical Systems (MEMS) resistive pressure sensor.

A target electrical signal value of the strain resistor or MEMS resistive pressure sensor is related to deformation amount of the strain resistor or MEMS resistive pressure sensor, the state information includes the target electrical signal value, and the control module 2 determines whether the wireless charger is in the target state or the non-target state based on the target electrical signal value.

In this implementation, with the strain resistor or MEMS resistive pressure sensor disposed, the protrusion 111 is pressed on the pressure-sensitive component 3, so that an electrical signal value (for example, voltage) output by the strain resistor or MEMS resistive pressure sensor can be changed when the strain resistor or MEMS resistive pressure sensor deforms. Thus, the control module 2 can pre-store a correspondence between the electrical signal value output by the strain resistor or MEMS resistive pressure sensor and the target state or non-target state, and then can determine whether the target electrical signal value corresponds to the target state or the non-target state when obtaining the target electrical signal value output by the strain resistor or MEMS resistive pressure sensor, thereby determining that the wireless charger is in the corresponding state. This can simplify the structure of the pressure-sensitive component 3.

In some embodiments, the pressure-sensitive component 3 is disposed on a flexible printed circuit board, and the flexible printed circuit board is disposed on the substrate 12, where in a case that a pressure toward the substrate 12 received by the upper cover plate 11 is less than or equal to a first preset pressure value, the pressure-sensitive component 3 resets under an elastic force of the flexible printed circuit board.

In an implementation, the first preset pressure value may be equal to 0 or greater than 0, which is not specifically limited herein.

In this implementation, the elastic force of the flexible printed circuit board drives the strain resistor or MEMS resistive pressure sensor to reset on the flexible printed circuit board, so that when the strain resistor or MEMS resistive pressure sensor resets on the flexible printed circuit board, the control module 2 receives state information indicating that the wireless charger provided in the embodiments of this application is in the target state.

In an implementation, an elastic structure may be disposed between the upper cover plate 11 and the substrate 12, so that when the upper cover plate 11 is not subjected to a pressure, the protrusion 111 is pushed away from the strain resistor or MEMS resistive pressure sensor under the elastic force provided by the elastic structure, allowing the strain resistor or MEMS resistive pressure sensor to reset. This is not specifically limited herein.

In an implementation, the pressure-sensitive component 3 may be distributed at different positions on the substrate 12. For example, as shown in FIG. 2, two pressure-sensitive components 3 are spaced apart on a surface of the substrate 12 facing the upper cover plate 11. Thus, when the upper cover plate 11 is subjected to an uneven force, at least a portion of the pressure-sensitive components 3 abuts against the protrusion 111 on the upper cover plate 11, thereby implementing the pressure detection function.

In some embodiments, as shown in FIG. 2, the wireless charger further includes a charging coil 51 and a charging interface 52, and the charging coil 51 and the charging interface 52 are both electrically connected to the pressure-sensitive component 3; where
in a case that the pressure value detected by the pressure-sensitive component 3 is greater than or equal to a second preset pressure value, the wireless charger turns on the charging coil 51; and
in a case that the pressure value detected by the pressure-sensitive component 3 is less than the second preset pressure value, the wireless charger turns off the charging coil 51.

The second preset pressure value may be equal to the first preset pressure value in the foregoing embodiments.

In an implementation, the charging coil 51 and the charging interface 52 may be the charging module 5 in the wireless charger, and the charging coil 51 may be a primary coil during wireless charging, which is used for electromagnetic induction with a secondary coil in the device to be charged, thereby implementing wireless charging.

In an implementation, the charging coil 51 may be thicker than the first coil 42. For example, the charging coil 51 is a charging coil with a thicker diameter, and the first coil 42 is a thinner coil made of enameled wire.

In an implementation, the pressure-sensitive component 3 can be connected to the charging interface 52 and the charging coil 51 through the control module 2, and the control module 2 may control the charging module 5 to turn on or off based on the detection results of the pressure-sensitive component 3, so as to stop charging the device to be charged while interrupting the magnetic force on the device to be charged, and to start to charge the device to be charged while starting the magnetic alignment on the device to be charged. The charging module 5 may directly turn on or off based on the output signal of the pressure-sensitive component 3.

In an implementation, the charging interface 52 can be any charging structure, such as a Type-C power port. The Type-C power port can serve as a power input interface and debugging interface for the wireless charger. In practical applications, the magnitude and direction of the magnetic force of the magnetic component 4 may be adjusted through the debugging interface.

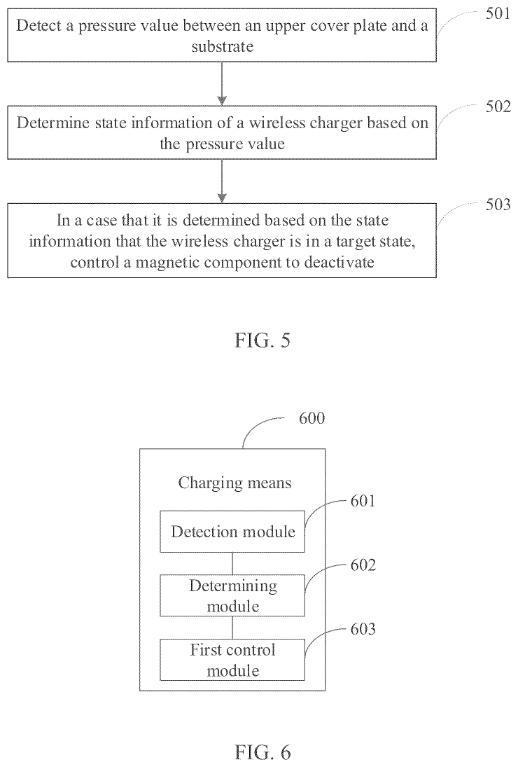

An embodiment of this application further provides a charging method, which can be applied to the wireless charger provided in the embodiments shown in FIG. 1 to FIG. 4. As shown in FIG. 5, the charging method includes the following steps.
Step 501. Detect a pressure value between the upper cover plate and the substrate.
Step 502. Determine state information of the wireless charger based on the pressure value.
Step 503. In a case that it is determined based on the state information that the wireless charger is in a target state, control the magnetic component to deactivate, where the magnetic component is configured to generate a magnetic force for attaching a device to be charged to the upper cover plate when activated.

The charging method provided in this embodiment of this application is the steps performed by the wireless charger provided in the embodiments shown in FIG. 1 to FIG. 4, with the same beneficial effects achieved. To avoid repetition, details are not described herein again.

In some embodiments, that the wireless charger is in a target state includes at least one of the following:
detecting that no device to be charged is carried on the upper cover plate;
detecting that a pressure received by the upper cover plate is less than a first preset pressure value; and
detecting that the number of times the pressure received by the upper cover plate is greater than or equal to the first preset pressure value is even.

In some embodiments, the method further includes:
in a case that it is determined based on the state information that the wireless charger is in a non-target state, controlling the magnetic component to generate a target magnetic force corresponding to the non-target state.

In some embodiments, in a case that the wireless charger includes a base hinged to the substrate, the method further includes:
obtaining a first included angle between the substrate and the base; and
the in a case that it is determined based on the state information that the wireless charger is in a non-target state, controlling the magnetic component to generate a target magnetic force corresponding to the non-target state includes:
in a case that it is determined based on the state information that the wireless charger is in the non-target state, determining the target magnetic force based on the first included angle and the pressure value, where the target magnetic force is a minimum magnetic force for attaching the device to be charged to the upper cover plate; and
controlling the magnetic component to output the target magnetic force.

In some embodiments, the method further includes:
in a case that it is determined based on the state information that the wireless charger is in the non-target state, controlling a charging interface to transmit acquired external electrical energy to a charging coil; and/or
in a case that it is determined based on the state information that the wireless charger is in the target state, controlling the charging interface to stop transmitting the acquired external electrical energy to the charging coil.

The charging interface transmitting the acquired external electrical energy to the charging coil may mean turning on the wireless charging module; and the charging interface stopping transmitting the acquired external electrical energy to the charging coil may mean turning off the wireless charging module.

The charging method provided in this embodiment of this application includes the processes performed by the wireless charger provided in the embodiments shown in FIG. 1 to FIG. 4, with the same effects achieved. To avoid repetition, details are not described herein again.

Referring to FIG. 6, an embodiment of this application further provides a charging means. The charging means may be a means (for example, the control module 2 in the embodiments shown in FIG. 1 to FIG. 4) in the wireless charger provided in the embodiments shown in FIG. 1 to FIG. 4. As shown in FIG. 6, the charging means 600 includes:
a detection module 601 configured to detect a pressure value between the upper cover plate and the substrate;
a determining module 602 configured to determine state information of the wireless charger based on the pressure value; and
a first control module 603 configured to, in a case that it is determined based on the state information that the wireless charger is in a target state, control the magnetic component to deactivate, where the magnetic component is configured to generate a magnetic force for attaching a device to be charged to the upper cover plate when activated.

In some embodiments, that the wireless charger is in a target state includes at least one of the following:
detecting that no device to be charged is carried on the upper cover plate;
detecting that a pressure received by the upper cover plate is less than a first preset pressure value; and
detecting that the number of times the pressure received by the upper cover plate is greater than or equal to the first preset pressure value is even.

In some embodiments, the charging means 600 further includes:
a second control module configured to, in a case that it is determined based on the state information that the wireless charger is in a non-target state, control the magnetic component to generate a target magnetic force corresponding to the non-target state.

In some embodiments, in a case that the wireless charger includes a base hinged to the substrate, the charging means 600 further includes:
an obtaining module configured to obtain a first included angle between the substrate and the base; and
the second control module includes:
a determining unit configured to, in a case that it is determined based on the state information that the wireless charger is in the non-target state, determine the target magnetic force based on the first included angle and the pressure value, where the target magnetic force is a minimum magnetic force for attaching the device to be charged to the upper cover plate; and
a control unit configured to control the magnetic component to output the target magnetic force.

In some embodiments, the charging means 600 further includes:
a third control module configured to, in a case that it is determined based on the state information that the wireless charger is in the non-target state, control a charging interface to transmit acquired external electrical energy to a charging coil; and/or
a fourth control module configured to, in a case that it is determined based on the state information that the wireless charger is in the target state, control the charging interface to stop transmitting the acquired external electrical energy to the charging coil.

The charging means 600 provided in this embodiment of this application can implement the processes of the method embodiment shown in FIG. 5, with the same beneficial effects achieved. To avoid repetition, details are not described herein again.

It should be noted that in the specification, the terms “include”, “comprise”, or any of their variants are intended to cover a non-exclusive inclusion, so that a process, method, article, or apparatus that includes a series of elements includes not only those elements but also other elements that are not expressly listed, or further includes elements inherent to such process, method, article, or apparatus. Without more restrictions, an element preceded by the statement “includes a . . . ” does not preclude the presence of other identical elements in the process, method, article, or apparatus that includes the element. In addition, it should be noted that the scope of the method and apparatus in the embodiments of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples may be combined in other examples.

Based on the foregoing description of the embodiments, persons skilled in the art can clearly understand that the method in the foregoing embodiments can be implemented through software on a necessary general hardware platform or through hardware only. In some embodiments, the technical solutions of this application entirely or the part contributing to the prior art may be implemented in a form of a computer software product. The computer software product is stored in a storage medium (such as a Read-Only Memory (ROM), a Random Access Memory (RAM), a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing implementations. These implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A wireless charger, comprising: a substrate; an upper cover plate; a pressure-sensitive component; and a magnetic component,
wherein:
the substrate and the upper cover plate are stacked in a first direction,
the upper cover plate is able to move relative to the substrate along the first direction, and
the pressure-sensitive component is disposed on a side of the substrate facing the upper cover plate,
wherein:
the pressure-sensitive component is electrically connected to the magnetic component,
the pressure-sensitive component is configured to detect a pressure value of the upper cover plate pressed on the substrate, and
the wireless charger adjusts at least one of magnetic direction or magnetic force of the magnetic component based on the pressure value.

2. The wireless charger according to claim 1,
wherein:
the magnetic component comprises a magnetic conductor and a first coil disposed around the periphery of the magnetic conductor, and
a radial direction of the magnetic conductor is the same as the first direction.

3. The wireless charger according to claim 2,
wherein:
the magnetic conductor is fixed on a side of the substrate facing the upper cover plate,
the upper cover plate is provided with a through hole, and
an end of the magnetic conductor is exposed outside the upper cover plate through the through hole.

4. The wireless charger according to claim 1, further comprising a base,
wherein:
the substrate is hinged to the base,
a first included angle is formed between the substrate and the base, and
a magnitude of a magnetic force generated by the magnetic component is positively correlated with the first included angle.

5. The wireless charger according to claim 1, wherein a protrusion is provided on a side of the upper cover plate facing the substrate, and the protrusion is disposed opposite the pressure-sensitive component, wherein
when the upper cover plate moves toward the substrate, the protrusion is pressed on the pressure-sensitive component.

6. The wireless charger according to claim 5, wherein when the upper cover plate moves toward the substrate, the protrusion is pressed on the pressure-sensitive component, causing the pressure-sensitive component to deform.

7. The wireless charger according to claim 6, wherein the pressure-sensitive component is disposed on a flexible printed circuit board, and the flexible printed circuit board is disposed on the substrate, wherein when a pressure toward the substrate received by the upper cover plate is less than or equal to a first preset pressure value, the pressure-sensitive component resets under an elastic force of the flexible printed circuit board.

8. The wireless charger according to claim 1, wherein further comprising: a charging coil; and a charging interface, wherein the charging interface and the charging coil are both electrically connected to the pressure-sensitive component,
wherein:
when the pressure value detected by the pressure-sensitive component is greater than or equal to a second preset pressure value, the wireless charger turns on the charging coil, and
when the pressure value detected by the pressure-sensitive component is less than the second preset pressure value, the wireless charger turns off the charging coil.

9. A charging method, performed by a wireless charger comprising a substrate, an upper cover plate, and a magnetic component, comprising:
detecting a pressure value between the upper cover plate and the substrate;
determining state information of the wireless charger based on the pressure value; and
when it is determined based on the state information that the wireless charger is in a target state, controlling the magnetic component to deactivate, wherein the magnetic component is configured to generate a magnetic force for attaching a device to be charged to the upper cover plate when activated.

10. The charging method according to claim 9, wherein that the wireless charger is in a target state comprises at least one of the following:
detecting that no device to be charged is carried on the upper cover plate;
detecting that a pressure received by the upper cover plate is less than a first preset pressure value; or
detecting that the number of times the pressure received by the upper cover plate is greater than or equal to the first preset pressure value is even.

11. The charging method according to claim 9, further comprising:
when it is determined based on the state information that the wireless charger is in a non-target state, controlling the magnetic component to generate a target magnetic force corresponding to the non-target state.

12. The charging method according to claim 11, wherein when the wireless charger comprises a base hinged to the substrate, the method further comprises:
obtaining a first included angle between the substrate and the base; and
when it is determined based on the state information that the wireless charger is in the non-target state, controlling the magnetic component to generate the target magnetic force corresponding to the non-target state comprises:
when it is determined based on the state information that the wireless charger is in the non-target state, determining the target magnetic force based on the first included angle and the pressure value, wherein the target magnetic force is a minimum magnetic force for attaching the device to be charged to the upper cover plate; and
controlling the magnetic component to output the target magnetic force.

13. The charging method according to claim 11, further comprising:
when it is determined based on the state information that the wireless charger is in the non-target state, controlling a charging interface to transmit acquired external electrical energy to a charging coil; or
when it is determined based on the state information that the wireless charger is in the target state, controlling the charging interface to stop transmitting the acquired external electrical energy to the charging coil.
